(19) United States
(12) Patent Application Publication
(10) Pub. No.: US 2010/0058582 A1
(43) Pub. Date: Mar. 11, 2010

(54) METHOD AND DEVICE FOR THE APPLICATION OF AN ELONGATED CONDUCTOR TO A SOLAR ELEMENT

(76) Inventors: Dominik Hofmann, Weggis (CH); Adolf Hofer, Lufingen (CH); Stefan Murer, Beckenried (CH)

Correspondence Address: FRASER CLEMENS MARTIN & MILLER LLC, 28366 KENSINGTON LANE, PERRYSBURG, OH, 43551, US

(21) Appl. No.: 12/556,630

(22) Filed: Sep. 10, 2009

(30) Foreign Application Priority Data
Sep. 11, 2008 (EP) 08164185.4

(51) Int. Cl. H01R 43/00; B23P 19/00

(52) U.S. Cl. 29/825; 29/745

(57) ABSTRACT

A method and device for the application of an elongated electric conductor to a solar element wherein the required length of the elongated electric conductor is readied and the conductor is strained through application of a tensile stress. The conductor is then fastened to the solar element. Straining of the elongated electric conductor is monitored to prevent exceeding of a tensile limit. During fastening onto the solar element at least one press-on roller is employed.

### FIELD OF THE INVENTION

The invention relates to a method and a device for attaching an elongated conductor to a solar element.

### BACKGROUND OF THE INVENTION

According to a previously known method, crystalline solar cells are contacted on the front side with conductive strips. According to patent disclosure DE 10 2006 006 715 A1, grippers are used to grip a conductive strip and place it on the solar cells in controlled manner. The conductive strip then has applied to it a longitudinal tensile stress before it is fastened onto the solar cells. Before the conductive strip is cut through, and before it is fastened onto the solar cells, the conductive strip is clamped onto the solar cells by means of a hold-down system. In this example, fastening of the conductive strip is effected by means of an adhesive substance.

However, this approach is not suitable for thin-film solar cells or for solar elements that have greater dimensions than the crystalline solar cells. With greater dimensions, the requirements for accuracy when placing the conductive strip are significantly higher. Furthermore, with greater dimensions that are characteristic of longer conductive strips, the curvature and any ripples of the conductive strips assume an increasingly important role. Moreover, it is important to ensure that despite their greater length the conductive strips have a contact resistance relative to the solar element that is as constant as possible. Any false alignments cause power losses.

If the conductive strip is stretched, hardening of the conductive strip can result. This hardening can cause damage to the crystals of a crystalline solar cell. Thin-film solar cells can also be damaged by the conductive strip if it is not applied with sufficient care. Stretching of the conductive strip can also cause brittleness which can result in micro-cracks which are undesirable.

### SUMMARY OF THE INVENTION

The task therefore presents itself of developing a method for contacting solar elements with an elongated conductor which avoids the disadvantages stated above. The method shall function reliably and reproducibly and shall be particularly suitable for the application of conductors that are longer than 300 mm.

A further objective of the invention is to provide a corresponding device that enables the method to be executed automatically.

It is regarded as an advantage of the invention that through the special method and the correspondingly designed device, homogeneous, low-resistance contactings are possible also over greater lengths.

Further advantages are the wrinkle- or crease-free application of long conductive strips, the high accuracy and outstanding reproducibility, as well as the assurance of a uniform transition resistance between the elongated conductor and the solar element.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a processing system according to the invention in a perspective view;

FIG. 2 is a second station of the processing system according to the invention in a perspective view;

FIG. 3 is a perspective view of a strip-feeder of the processing system according to the invention;

FIG. 4A is a perspective view of a cutting/clamping unit of the processing system according to the invention;

FIG. 4B is a sectional view of the cutting/clamping unit according to FIG. 4A;

FIG. 5 is a perspective view of a pull-out carriage of the processing system according to the invention;

FIG. 6 is a perspective view of a roll-on carriage of the processing system according to the invention;

FIG. 7A is a first step of a method according to the invention in a cross-section view;

FIG. 7B is a second step of a method according to the invention in a cross-section view;

FIG. 7C is a cutaway enlargement of FIG. 7B;

FIG. 7D is a further step of a method according to the invention in a cross-section view;

FIG. 7E is a further step of a method according to the invention in a perspective view;

FIG. 7F is a further step of a method according to the invention in a cross-section view;

FIG. 7G is a further step of a method according to the invention in a perspective view;

FIG. 7H is a further step of a method according to the invention in a cross-section view;

FIG. 7I is a further step of a method according to the invention in a cross-section view;

FIG. 7J is a further step of a method according to the invention in a cross-section view;

FIG. 7K is a further step of a method according to the invention in a cross-section view;

FIG. 8 is a diagrammatic cross section through a solar element with two conductors; and

FIG. 9 is a diagrammatic plan view of a solar element with two conductors.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The present invention is concerned with a partial aspect of the manufacturing of solar elements. The term “solar element” is used here as generic term for solar cells, solar modules, and solar systems. The invention is independent of whether the solar elements are crystalline, polycrystalline, or amorphous. The invention can also be applied with particular advantage to thin-film solar elements. Application of the invention is not restricted to silicon solar cells. It can also be applied to other types of solar cells (e.g. organic solar cells).

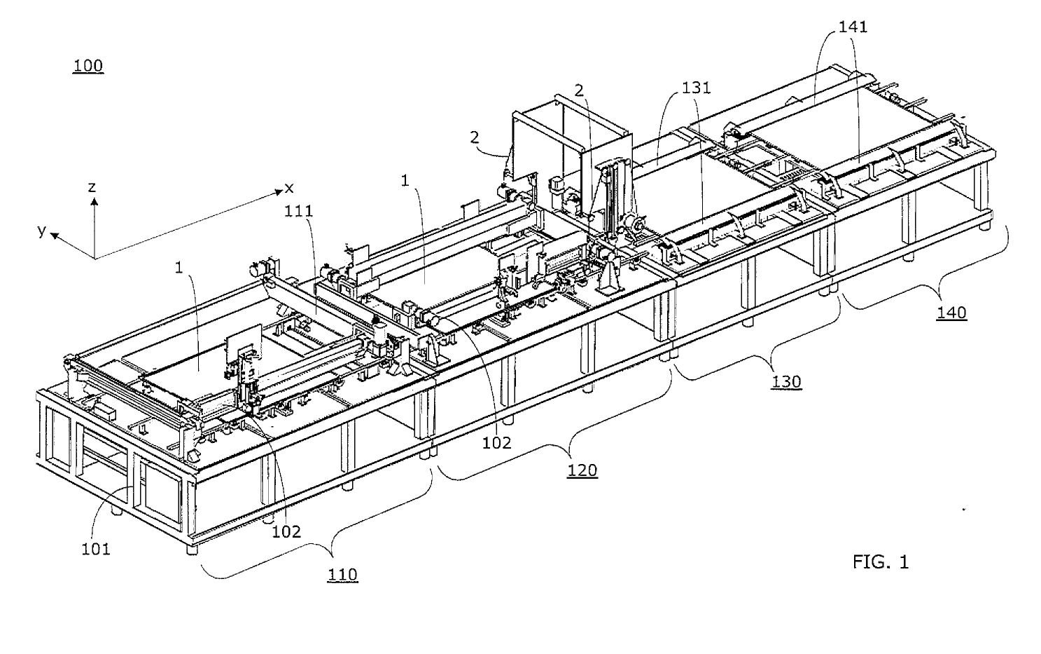

Typically, at least some of the manufacturing steps are executed in an automated processing system 100. A corresponding processing system 100 according to a first embodiment of the invention is shown in FIG. 1. The solar elements 1 pass through the processing system 100 from left to right (in the x direction) and are moved by conveyor systems 102 in the x direction. As substructure, the processing system 100 contains a truss, which is hereinafter referred to as truss 101. This truss 101 can stand on a base and supports the elements of the processing system 100 as shown in FIG. 1. In the example shown, the processing unit 100 comprises a first station 110, a second station 120, a third station 130, and a fourth station 140.

The first station 110 is designed to apply via a dispenser 111 a special adhesive substance to the solar elements 1 in one, two, or more parallel lines. The number of the adhesive-substance lines is adapted to the number of parallel elongated conductors that should be applied to the solar elements 1. Shown in FIG. 1 is a processing system 100 wherein two parallel adhesive-substance lines and two parallel elongated conductors 2 are applied.

The special adhesive substance is designed in such manner that it is electrically conductive either already before hardening or only after hardening. The special adhesive substance is preferably pasty so that it can be applied from the dispenser 111 to the solar elements 1 in precisely dispensed quantities. Particularly suitable is a special adhesive substance that contains electrically conductive metal particles. Preferable is a conventional silver-conductive adhesive. Depending on the number of the desired parallel lines of adhesive substance, the dispenser 111 can have one, two, or more adhesive substance nozzles. Alternatively, a slit nozzle can be employed that has a corresponding number of outlet openings. In FIG. 1, the dispenser 111 with the nozzles is integrated in a cross-beam that extends in the y direction.

The term “elongated conductor 2” is used here for conductive strips, conductive tapes, and conductive tracks. The cross section of the elongated conductor 2 can be circular (round wire) or semicircular, oval, square, rectangular, hexagonal, or octagonal. Preferably, a flat conductive strip with rectangular cross section is used as the elongated conductor 2.

Preferably, copper is used as material. Aluminum, silver, gold, platinum and titanium are also suitable. The metal alloys that are commonly used in semiconductor technology can also be used as conductor. Particularly preferable is a tinned copper conductor.

If a copper conductor is used, it should have a tensile strength with a value below Rm=250 N/mm². At values above 250 N/mm² there is a danger when straining of embrittlement and formation of micro-cracks. Designated as yield point with Re is that tensile stress at which flow begins without the tensile stress being further increased. The term “strain” is used here as a synonym for the words stretch, extend, elongate, tauten.

Straining is performed so that the conductor 2 has applied to it a predefined tensile stress in the longitudinal direction. Through straining of the conductor 2 particularly advantageous conductor surfaces are created.

The conductor 2 is preferably strained so that slight plastic deformation occurs to eliminate any curvature of the conductor 2. In other words, straining takes place so that the yield point Re is minimally exceeded.

Preferably, straining of the conductor 2 is controlled by the straining being defined as a percentage of the pull-out length before straining and the processing unit 100 being correspondingly set. The parameter for straining is preferably between 1 and 17% of the pulled-out length before straining. Particularly preferable is a parameter that has a value between 1 and 5%.

Stretching of the elongated conductor 2 is monitored to prevent exceeding of a tensile limit K. The tensile limit K can be defined in various different ways. In the present case, the said parameter serves as tensile limit K. Instead of defining the tensile limit K as a percentage extension of the pull-out length, the tensile limit K can also be defined as, for example, a maximum tensile stress. The maximum tensile stress is defined in such manner that straining of the conductor 2 lies within the specified range of the parameter. The tensile limit K can also, for example, be expressed as a percentage yield point Re. In this case, the tensile limit K is between 100 and 117% of the yield point Re. Preferably, the tensile limit K is between 100 and 105% of the yield point Re. In other words, the tensile limit K is slightly above the yield point Re.

In the second station 120 the desired number of elongated conductors 2 is applied to the solar elements 1. Shown in FIG. 1 is a processing system 100 in which in the second station 120 two parallel elongated conductors 2 are attached.

In the example shown, the third and fourth stations 130, 140 are identically embodied and serve to harden the special adhesive substance by means of the heat generated by infrared radiators 131, 141. Instead of the infrared radiators 131, 141, other heat sources such as, for example, induction coils or resistance heating elements can also be used.

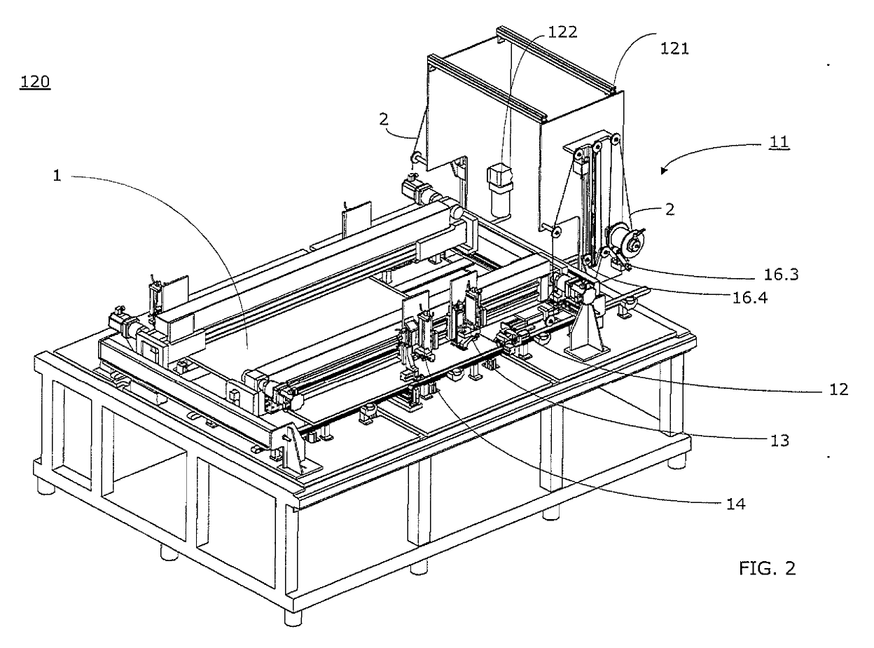

FIG. 2 shows details of the second station 120 of the first embodiment of the invention. In the second station 120, two elongated conductors 2 are pulled out simultaneously, strained, cut off, and rolled onto the lines of adhesive substance. The lines of adhesive substance cannot be seen in the figures. In the first embodiment shown, the corresponding elements of the second station 120 are constructed symmetrically. The corresponding elements are arranged along both side-edges of the solar elements 1. Both elongated conductors 2 can be attached to the solar elements 1 simultaneously.

The said elements of the second station 120 are described in more detail below. The following explanation is given only in relation to the visible elements that are arranged on the right side of the solar elements 1 (viewed in the x direction) and can be transferred 1:1 to the elements that are situated on the left side of the second station 120.

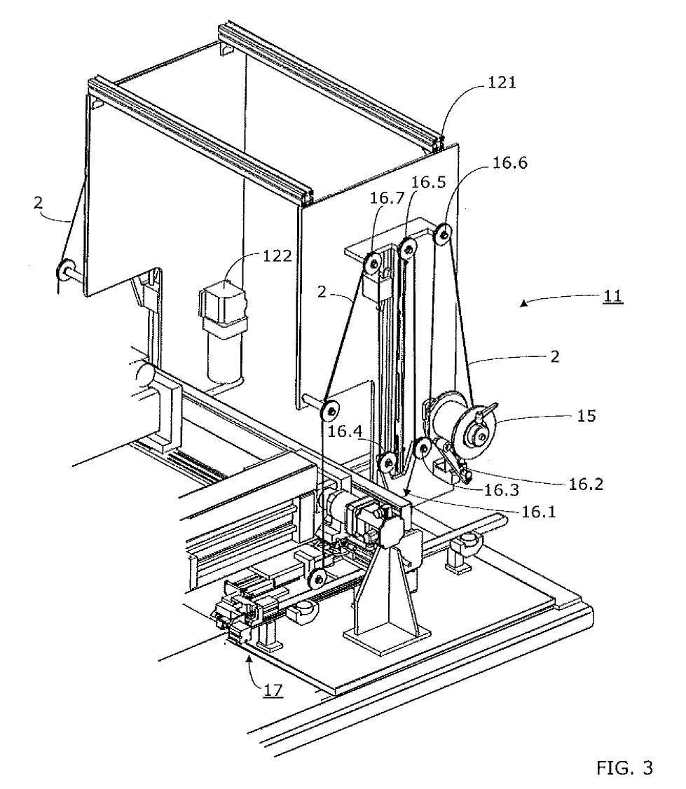

To make the elongated conductor 2 available in sufficient length, a strip feeder 11 is provided. As shown in more detail in FIG. 3, the strip feeder 11 contains a drum 15 from which the conductor 2 can be unrolled. Starting from the drum 15, the conductor 2 is guided diagonally upwards. There, the conductor 2 passes around a locationally fixed diverter pulley 16.6 and vertically downwards to a first reversing pulley 16.3 of a weight-loaded compensator 16.1. From there, the conductor 2 passes upwards again, where it passes around a locationally fixed reversing pulley 16.5. From there, the conductor 2 passes vertically downwards again and around a second reversing pulley 16.4 of the compensator 16.1. Starting from the second reversing pulley 16.4, the conductor 2 again passes upwards and around a locationally fixed diverter pulley 16.7. The compensator 16.1 with its two reversing pulleys 16.3 and 16.4 hangs in two loops of the conductor 2. Due to the weight of the compensator 16.1 (the weight is preferably adjustable) the conductor 2 is always under tension. Furthermore, the compensator 16.1 compensates oscillations which can occur when unwinding the conductor 2 from the drum 15. The drum 15 is preferably motor-driven (a corresponding drum motor 122 of the left strip feeder 11 can be seen in FIG. 2 and FIG. 3). The drum 15 can be designed to be replaceable. An optional supply monitoring 16.2 can be arranged in the area of the drum 15. The right and the left strip feeders 11 can be fastened to a frame 121 or box, which bridges the solar elements 1 that move in the x direction.

Preferably, four sensors are arranged along the vertical path of the compensator 16.1 to regulate the drum motor 122 of the drum 15.

The use of a drum motor 122 assures that when pulling out the elongated conductor 2, the tensile stress in the conductor 2 is not excessively high.

Overall, the strip feeder 11 allows a continuous and certain feeding of the required conductor 2.

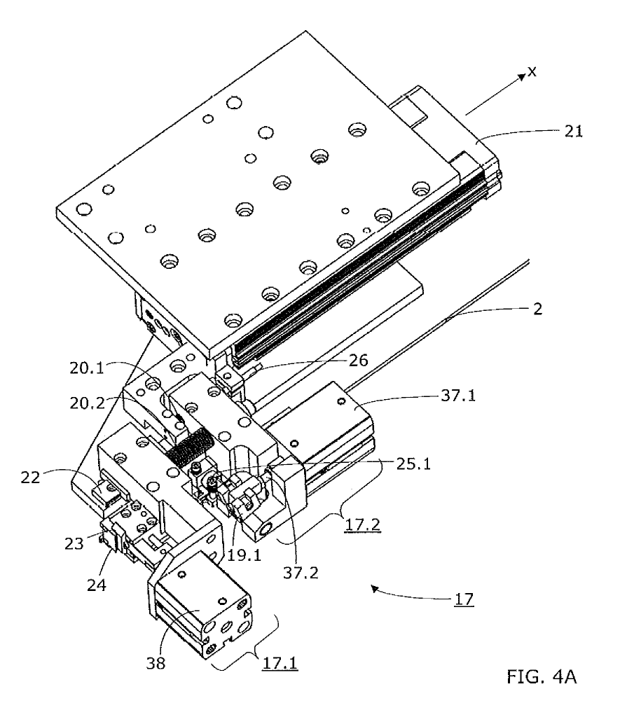

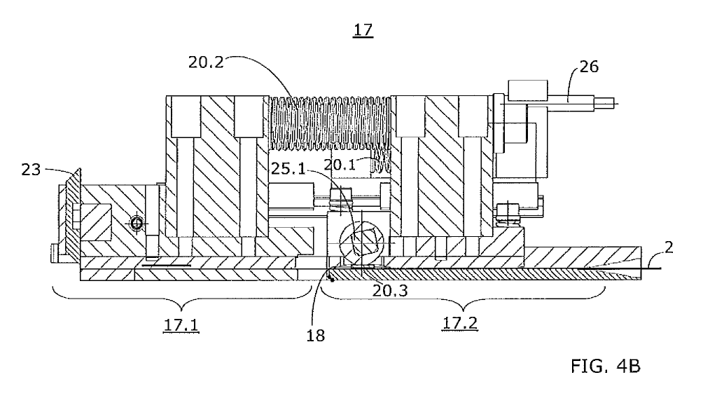

A further element that is used is a cutting/clamping unit 17, which can be seen more clearly in FIGS. 4A and 4B. The cutting/clamping unit 17 contains two subassemblies. The subassembly referenced with 17.1 is here referred to as “cutting head” and the subassembly referenced with 17.2 is referred to as “clamping unit”. In FIGS. 4A and 4B it can be seen that the elongated conductor 2 runs into the clamping unit 17.2 from the right (coming from the last diverter pulley of the strip feeder).

The cutting/clamping unit 17 in its entirety is movable in the x direction with a pneumatic carriage 21. Preferably, in the x direction two positions of the cutting/clamping unit 17 are prespecified. Held by guiding parts, the elongated conductor 2 passes under and through a clamping plate 18 to a cutting blade 23. The clamping plate 18 is pressed upwards by compression springs 20.3 or, if the elongated conductor 2 should be clamped, pressed downwards onto the elongated conductor 2 by a pneumatic clamping cylinder 37.1 through a piston rod 37.2, a fork 19.1, and an eccentric shaft 25.1.

The cutting blade 23 is actuated by the pneumatic cutting cylinder 38 via a link 24. Clamping unit 17.2 and cutting head 17.1 are movably borne on a linear guide 22, the clamping unit 17.2 of a first compression spring 20.1 and the cutting head 17.1 of a second compression spring 20.2 being supported relative to the pneumatic carriage 21. An optional proximity sensor 26 detects the position of the cutting/clamping unit 17 and can be used for crack monitoring of the elongated conductor 2 when straining (this step is explained later).

In a lateral cross section view in FIG. 4B it can be seen that by turning the eccentric shaft 25.1 the clamping plate 18 is pressed downwards. The compression spring 20.3 produces an opposing force. Through the clamping plate 18 being pressed downwards, the elongated conductor 2 is clamped fast. The clamping fast is initiated by a translatory movement of the piston rod 37.2 in the negative x direction. This translatory movement is transformed into a tilting movement of the fork 19.1 (see FIG. 4A). The tilting movement causes a turning movement of the eccentric shaft 25.1. This turning movement causes the clamping plate 18 to be pressed downwards.

The cutting/clamping unit 17 also serves for temporary one-sided holding-fast of the elongated conductor 2. Furthermore, the cutting/clamping unit 17 can cut the elongated conductor 2, which takes place through a movement of the cutting blade 23. The movement of the cutting blade 23 is generated by the pneumatic cutting cylinder 38 (see FIG. 4A).

Provided in addition to the cutting/clamping unit 17 are a so-called pull-out carriage 14 and a so-called roll-on carriage 13 (see FIG. 2).

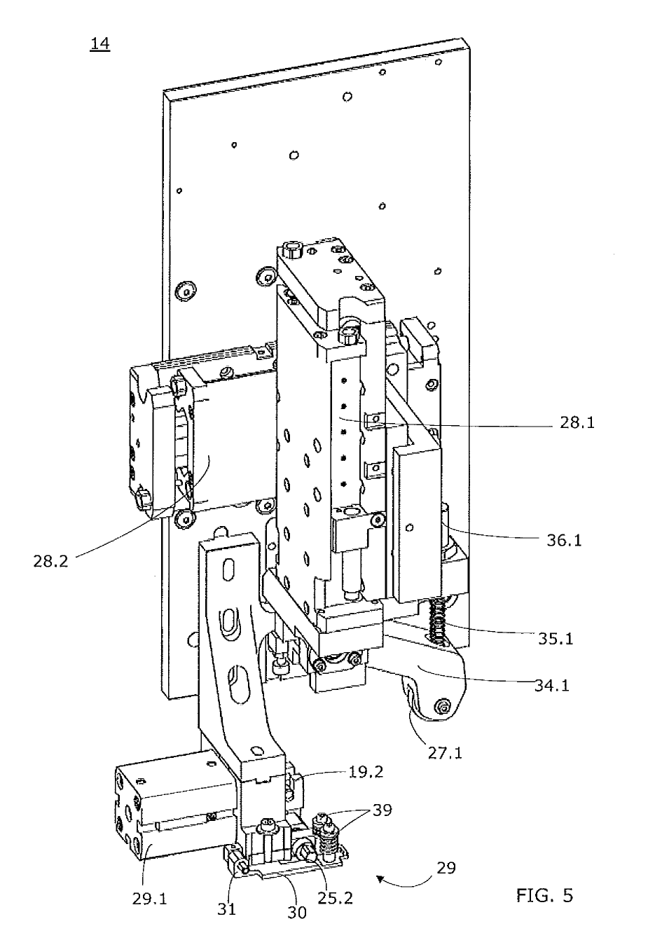

The pull-out carriage 14 is shown in FIG. 5. The pull-out carriage 14 has a gripper 29 to temporarily grasp (clamp fast) the elongated conductor 2 and a spring-borne pressure roller 27.1. The pressure roller 27.1 sits on a lever arm 34.1 which can be lowered by a vertical pneumatic carriage 28.1. The lever arm 34.1 has applied to it a spring force of a compression spring 35.1 and can be adjusted with a threaded bolt 36.1. In the lower position, the press-on force is applied by the compression spring 35.1, the spring force being adjusted by changing the pretension with the threaded bolt 36.1.

The vertical pneumatic carriage 28.1 is in turn movable in the x direction by a horizontal pneumatic carriage 28.2. The gripper 29 is similar to the clamping unit 17.2 of the cutting/clamping unit 17, with a clamping plate 30 which is movable about a swivel axle 31 acting from below.

The gripper 29 of the pull-out carriage 14 has a pneumatic cylinder 29.1 which by means of a piston rod (not visible) converts a translatory movement into a tipping movement of a fork 19.2. The tipping movement is converted into a turning movement of an eccentric shaft 25.2. By means of the eccentric movement of the eccentric shaft 25.2, the clamping plate 30 is moved upwards. Springs 39 press the clamping plate 30 downwards.

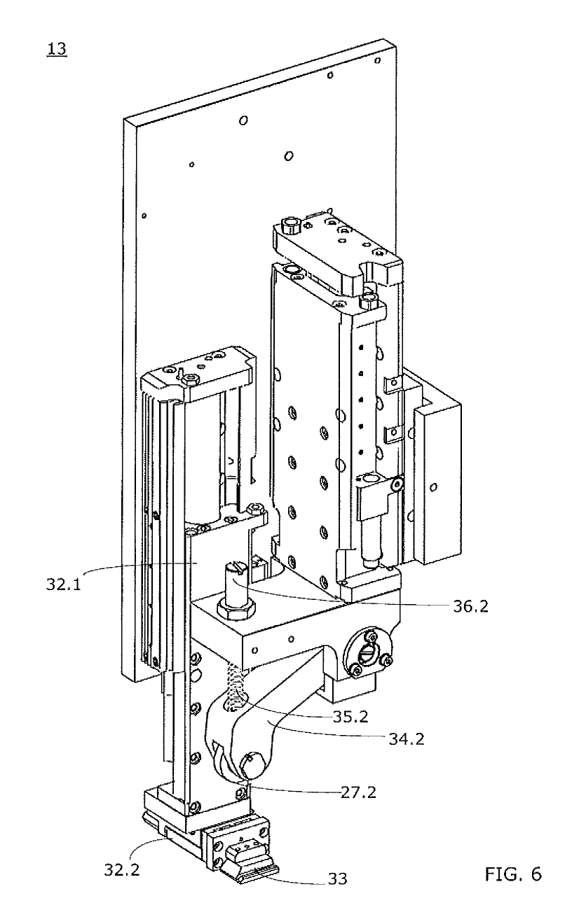

As shown in FIG. 6, the optional roll-on carriage 13 also has a pressure roller 27.2 which, however, in the embodiment shown is fastened so as to be movable only vertically. As in the case of the pull-out carriage 14, the pressure roller 27.2 is borne in a swivel arm 34.2. In the lower position, the press-on force is applied by a compression spring 35.2, the spring force being adjustable by changing the pretension with the threaded bolt 36.2.

The tape guide 33 of the roll-on carriage 13 can be moved with a vertical pneumatic carriage 32.1 (acting in the z direction) and the horizontal pneumatic carriage 32.2 acting in the y direction under the pulled-out elongated conductor 2. When this is done, first the tape guide 33 is lowered by a movement in the negative z direction and then the tape guide 33 is pushed under the elongated conductor 2 by a horizontal movement in the negative y direction.

Preferably, the first and second stations 110, 120 can be moved ±10 mm in the y direction, for example with micrometer screws, so as to perform, for example, a fine adjustment. Preferably, the pressure rollers 27.1, 27.2 can additionally be moved in the y direction relative to the gripper 29 and the tape guide 33.

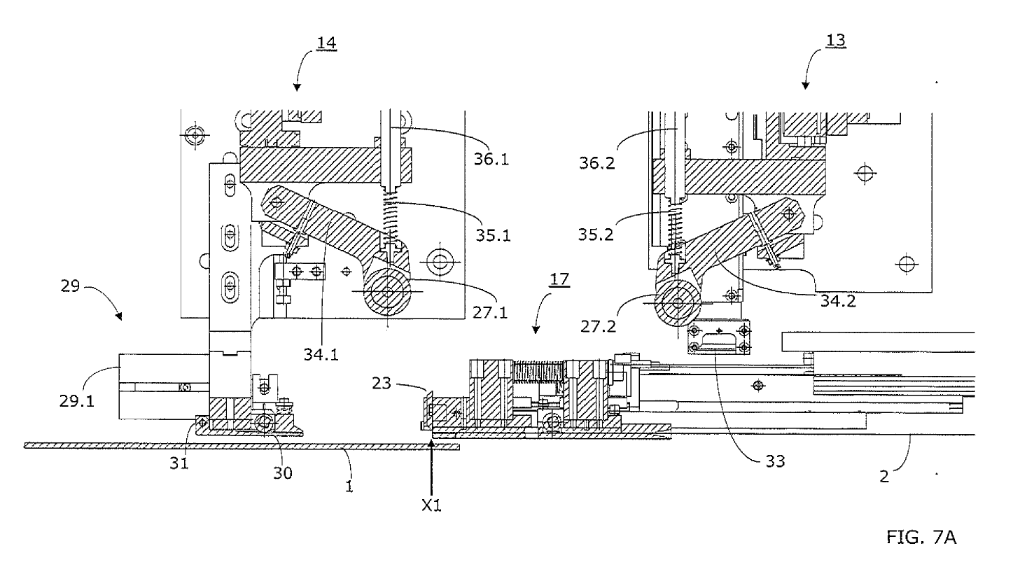

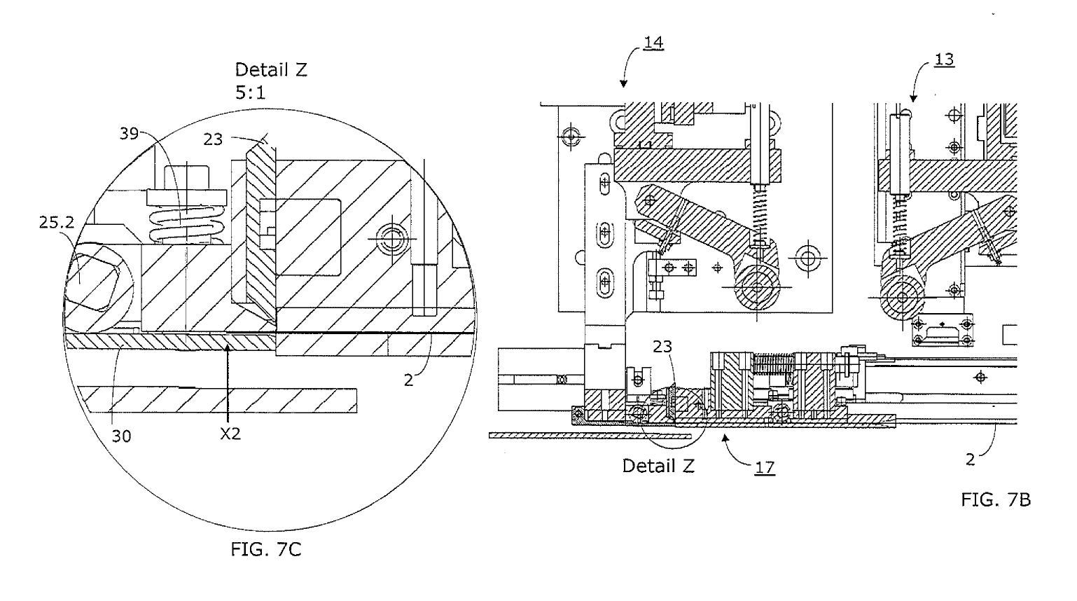

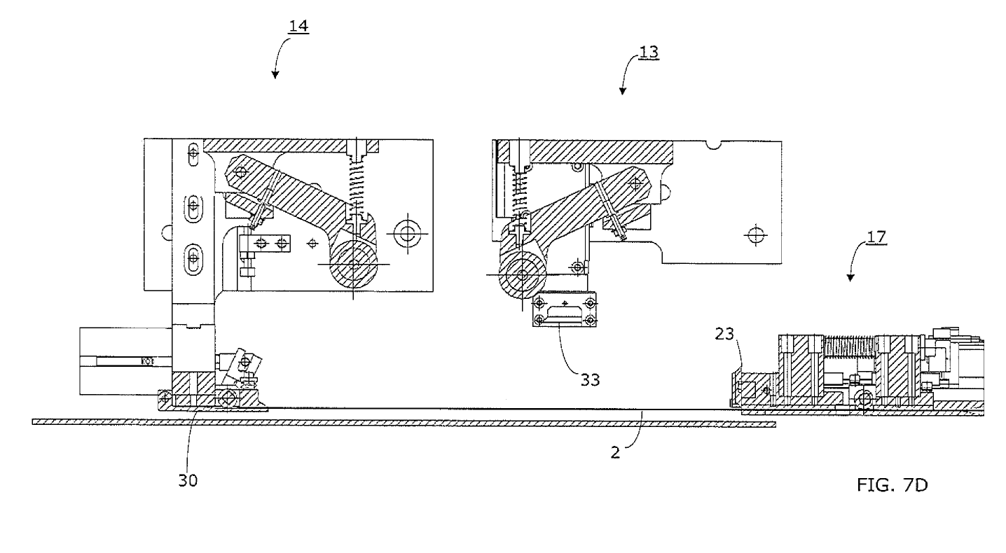

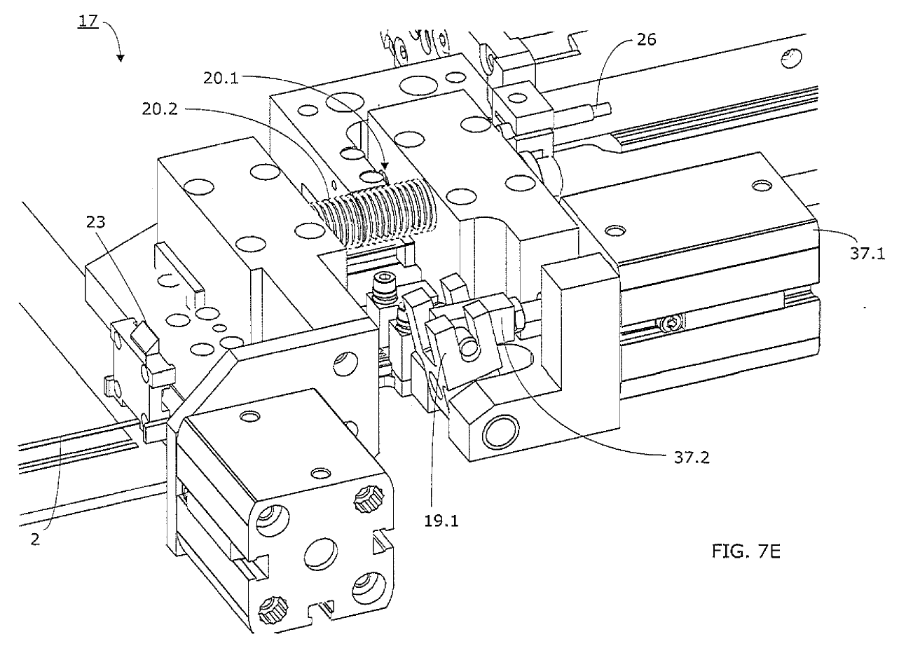

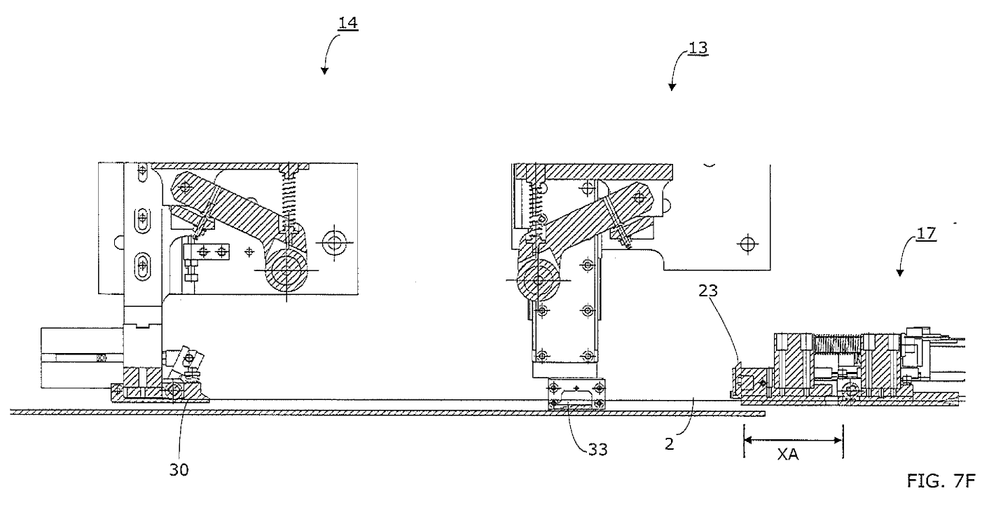

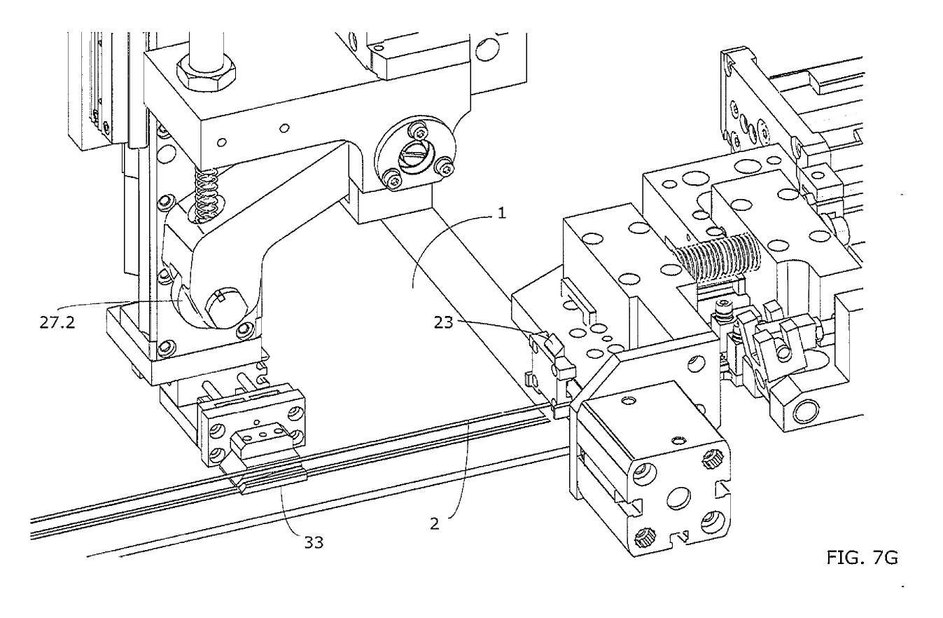

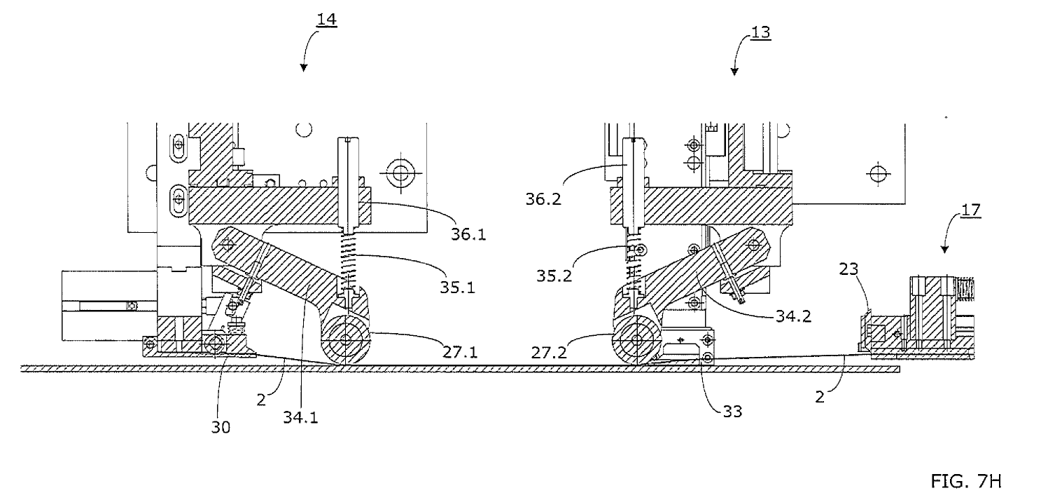

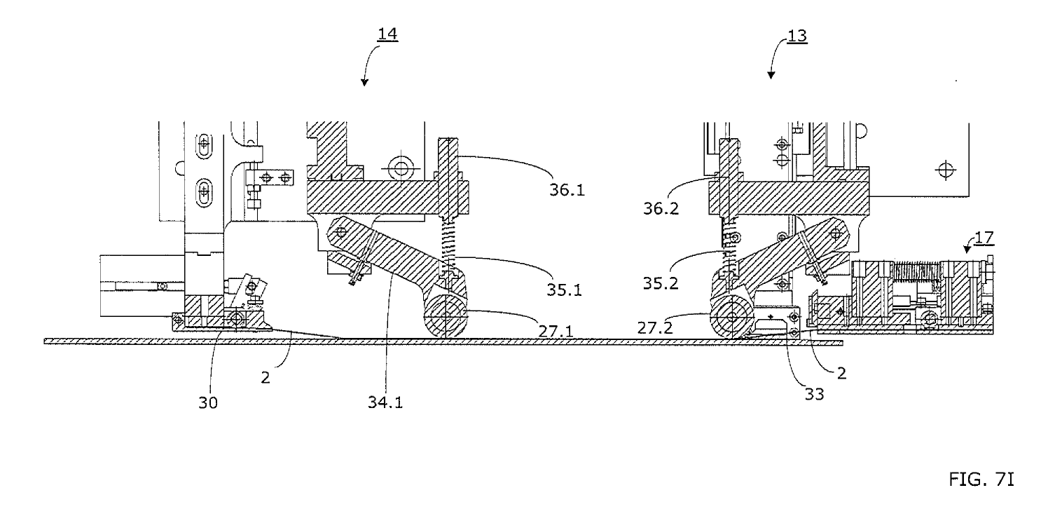

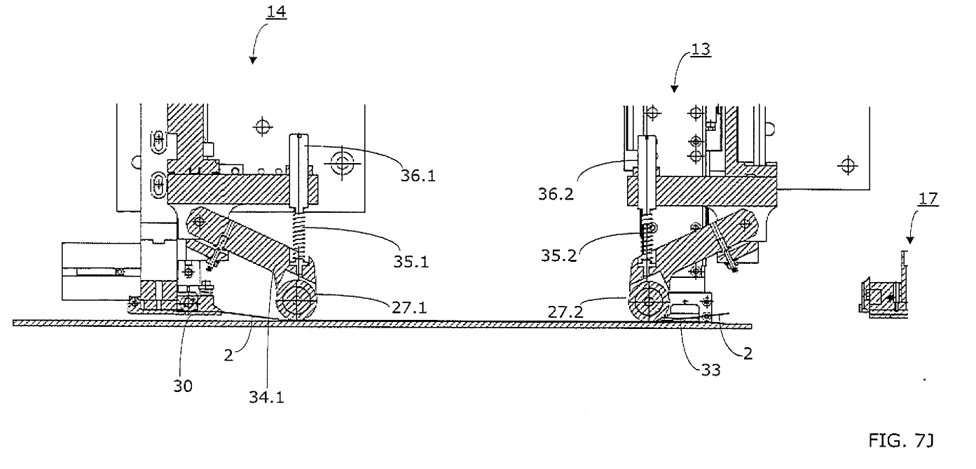

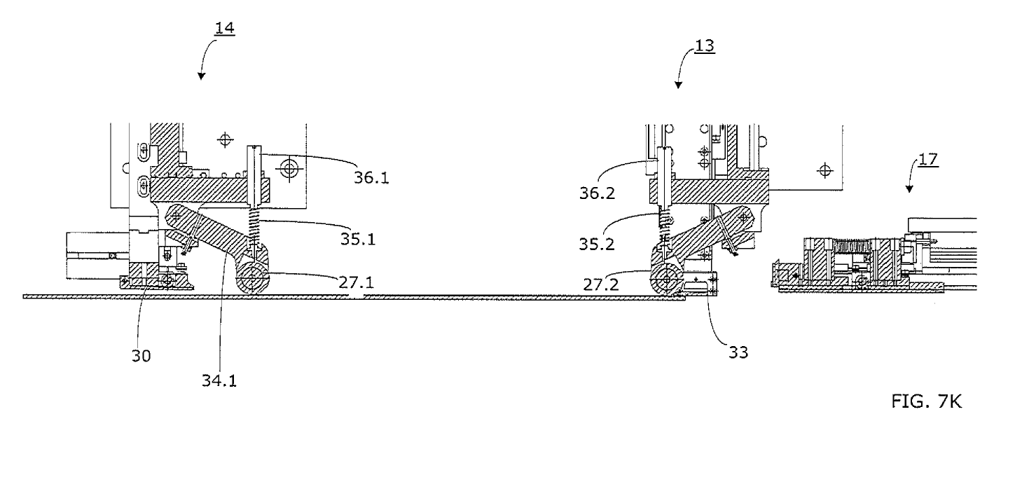

Now that the basic elements of the second station 120 have been described, the method according to the invention will be described in individual steps. The following description and the representation in the FIGS. 7A to 7K relate to a particularly preferred embodiment of the invention. The method can, however, also be realized with fewer steps.

FIG. 7A shows the starting position. The solar element 1, which is to be provided with at least one elongated conductor 2, is located below the pull-out carriage 14. A short end-piece of the elongated conductor 2 is held by the cutting/clamping unit 17. In a previous step (not shown), the elongated conductor 2 was cut off and the end of the elongated conductor 2 is at position X1.

In a second step, which is shown in FIG. 7B, the pull-out carriage 14 has been moved in the direction of the cutting/clamping unit 17. In this movement the pull-out carriage 14 presses the cutting head 17.1 of the cutting/clamping unit 17 back (in the positive x direction), while the pneumatic carriage 21 is locationally fixed (FIG. 4A). During the movement the compression spring 20.2 is compressed. Through this return movement of the cutting head 17.1 a part of the free end of the elongated conductor 2 is released, i.e. a piece of the elongated conductor 2 projects freely from the cutting head 17.1. In the cutout enlargement (Detail Z) in FIG. 7C, the position of the end of the elongated conductor 2 is referenced with X2.

The gripper 29 of the pull-out carriage 14 now grasps the free end of the elongated conductor 2. This takes place through the pneumatic cylinder 29.1 initiating a turning movement of the eccentric shaft 25.2 as described. By means of the eccentric movement of the eccentric shaft 25.2, the clamping plate 30 is moved in such manner that the elongated conductor 2 is clamped, as shown in FIG. 7C. The clamping unit 17.2 of the cutting/clamping unit 17 is now released, i.e. the clamping fast of the conductor 2 in the clamping unit 17.2 is released.

In a next step, which is shown in FIG. 7D, the pull-out carriage 14 moves to the left (in the negative x direction) and thereby pulls out the elongated conductor 2. Preferably, while the conductor 2 is being pulled out, the drum motor 122 runs, to turn the drum 15 along with it. When this is done, the roll-on carriage 13 automatically follows the pull-out carriage 14 (this step is optional). Note that the distance that the pull-out carriage 14 executes relative to the cutting/gripping unit 17 is significantly greater than the distance shown in FIG. 7D. Preferably, distances of from 300 mm to 2000 mm can be traveled.

Instead of pulling out or unwinding the elongated conductor by a translatory movement of the pull-out carriage 14, in another embodiment this step can also be executed by the cutting/clamping unit 17 through the latter moving in the negative x direction. Handing over of the free end of the conductor 2 can then take place at the end of this movement of the cutting/clamping unit 17. Readying of the elongated conductor 2 can also take place through a combination of movements of the cutting/clamping unit 17 and the pull-out carriage 14.

In a next step, which is shown in FIG. 7E, the elongated conductor 2 is again clamped fast in the cutting/clamping unit 17. Clamping-fast again takes place through actuation of the pneumatic clamping cylinder 37.1. The elongated conductor 2 is then strained by a further extension of the pull-out carriage 14. When this is done, the cutting/clamping unit 17 moves, pulled by the elongated conductor 2, against the spring force of the compression spring 20.1, because at this moment the pneumatic carriage 21 is locationally fixed. With this step the compression spring 20.1 is compressed until the clamping unit rests against two stops (e.g. rubber cylinders pressed into drilled holes). The compression spring 20.1 thus has the function of resetting the compression unit 17.2 in the direction of the proximity sensor 26 (i.e. in the x direction) when straining is not taking place. If the elongated conductor 2 were to crack, the clamping unit 17.2 would be automatically reset in the direction of the proximity sensor 26 by the force of the compression spring. A crack of the conductor strip can thus be detected. In this embodiment crack-monitoring takes place by means of the proximity sensor 26 which detects this relative movement. Other means of crack-monitoring can also be employed. For example, a resistance measurement of the elongated conductor 2 can be performed to allow detection of crack formation or complete snapping of the conductor 2 based on a change in resistance. A force sensor (for example a piezo element) can, however, also be used to monitor the tensile stress in the elongated conductor 2 and to detect a separation.

In a next step, which is not shown, the pull-out carriage 14 travels back (i.e. the travel distance that was covered for straining is retraced) until the proximity sensor 26 detects the cutting/clamping unit 17 in the starting position again. By means of these intermediate steps the elongated conductor 2 was stretched in controlled manner.

In a next step, which is shown in FIG. 7F, the clamping plate 18 of the cutting/clamping unit 17 is released. The elongated conductor 2 is then stretched further by means of the pull-out carriage 14 moving a travel distance XA further to the left. The travel distance XA is approximately equal to the distance between the clamping plate 18 and the cutting blade 23. This step is preferably executed because the elongated conductor 2 cannot in any area be strained more than once. Alternatively, in an intermediate step, the corresponding short length of the conductor 2 (i.e. the length that was already strained) is cut off and removed. If pulling-out of the travel path XA or cutting-off of the corresponding length is not executed, in the next performance of the sequence of steps according to the invention a second straining of the corresponding short length would occur.

In a next step, which is shown in FIG. 7G, the elongated conductor 2 is now clamped fast again in the cutting/clamping unit 17. The tape guide 33 of the roll-on carriage 13 now passes under the pulled-out elongated conductor 2. For this purpose, the tape guide 33 can be moved with the vertical pneumatic carriage 32.1 and the horizontal pneumatic carriage 32.2 that acts in the y direction.

Now, as shown in FIG. 7H, the press-on rollers 27.1, 27.2 of the pull-out carriage 14 and of the press-on carriage 13 are lowered downwards onto the elongated conductor 2. The press-on rollers 27.1 or 27.2 are preferably lowered by pneumatic cylinder.

The press-on carriage 13 then travels back as far as the cutting/clamping unit 17, as shown in FIG. 7I, and by this movement rolls the elongated conductor 2 onto the solar element 1. The distance traveled in doing so is considerably longer than shown here. In parallel, the press-on roller 27.2 is pneumatically moved against the cutting/clamping unit 17, to completely roll-on the outstanding section of conductor between the two press-on rollers 27.1, 27.2.

The press-on roller 27.1 of the pull-out carriage 14 then travels back and the gripper 29 is opened to release the end of the elongated conductor 2. The elongated conductor 2 can now be cut off with the cutting blade 23. Now, or at another suitable point in time, the cutting/clamping unit 17 can be moved back into the starting position as indicated in FIG. 7J.

Thereafter, if necessary, the end-pieces of the elongated conductor 2 are rolled-on with the press-on rollers 27.1, 27.2, as indicated in FIG. 7K.

Thereafter the press-on rollers 27.1, 27.2 are raised and the individual elements moved into the starting position. Preferably, the cutting/clamping unit 17 travels in advance and the pull-out and roll-on carriages 14, 13 follow into their respective starting positions.

The pull-out carriage 4 according to the invention fulfills the following conditions:
It is designed to take (unroll) the elongated conductor 2 from the stock (strip feed 11);
It is movable in at least the x direction;
It is optionally movable in the y direction (for solar elements 1 of different widths);
It is optionally movable in the z direction (for solar elements 1 of different thicknesses);
It travels a precisely defined distance further, to strain the elongated conductor 2;
It has at least one press-on roller 27.1 to roll-on the elongated conductor 2.

Furthermore, the pull-out carriage 14 can preferably engage in mechanical interaction with the cutting/clamping unit 17 to expose an end of the conductor 2 and be able to grip this free end with the gripper 29.

The roll-on carriage 13 according to the invention has at least one press-on roller 27.2 to roll-on the elongated conductor 2. The roll-on carriage 13 preferably has a tape guide 33. The employment of such a roll-on carriage 13 is optional. The rolling-on can also take place completely with the pull-out carriage 14, this variant being suitable for relatively short rolling-on lengths since otherwise the guiding function of the roll-on carriage 13 is absent.

The cutting/clamping unit 17 serves to hold fast the elongated conductor 2 as well as having means to cut off the conductor 2. Preferably the cutting/clamping unit 17 has one or more sensors (e.g. the proximity sensor 26) to monitor the straining of the elongated conductor 2.

In a preferred embodiment a sensor (preferably a strain gauge) is employed on the cutting/clamping unit 17 or on the pull-out carriage 14 to determine the tensile stress on the elongated conductor 2.

The processing system 100 is so designed that the elongated conductor 2 can be placed onto and rolled onto the special line of adhesive substance with absolute accuracy. Finally, an optional cover strip can be rolled out over the conductor 2. The cover strip is so applied as to ensure that there is no trapped air underneath the cover strip.

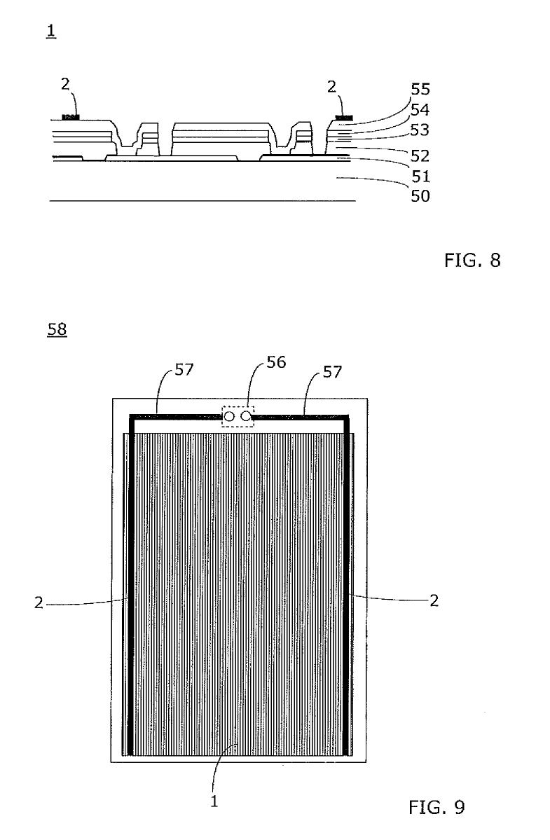

Shown in FIG. 8 is a diagrammatic not-to-scale section through a solar element 1. Visible in this cross-sectional view is the layered construction of a solar element 1. The illustrated solar element 1 comprises (from bottom to top) a glass substrate 50 onto which a molybdenum layer 51 is applied as contact. Above the molybdenum layer 51 are the semiconductor layers 52 and 53. In the present example these are a CIGS layer 52 and a CdS layer 53 (CIGS here standing for Cu(In,Ga)Se₂ and CdS for cadmium sulfate). Arranged above this semiconductor layer 52 and 53 are contact layers 54, 55, the layer 54 being an i-ZnO layer (intrinsic zinc oxide layer) and the layer 55 a Zn:Al alloy layer (zinc-aluminum alloy layer). Situated on the layer 55 are the conductors 2, which are applied with the method according to the invention.

Shown in FIG. 9 in a diagrammatic not-to-scale illustration is a solar module 58 with a solar element 1. Arranged along the side edges of the solar element 1 are the elongated conductors 2. Also provided for the purpose of connecting the elongated conductor with a connecting box 56 are two lateral conductive strips 57. The conductive strips 57 and the connecting box 56 are applied in a separate work-step. The solar module 58 can have, for example, the following dimensions (length to width): 1300 mm×1100 mm.

The invention can be used for front-side as well as back-side contacting of solar elements 1.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for the application to a solar element of an elongated electric conductor comprising the steps of:
a. readying of a predetermined length of the elongated electric conductor;
b. straining of the elongated electric conductor by application of a tensile stress;
c. fastening the elongated electric conductor onto the solar element;
d. monitoring the straining of the elongated electric conductor to prevent a tensile limit from being exceeded, which limit lies above a yield point of the elongated electric conductor; and
e. during fastening, employing a press-on roller to roll the elongated electric conductor onto the solar element.

2. The method according to claim 1 wherein during readying, a free end of the elongated electric conductor is clamped fast by a clamping unit and by a translatory movement of the clamping unit is unwound from a drum.

3. The method according to claim 2 wherein the drum is motor-driven to assist the unwinding.

4. The method according to claim 1 wherein during straining the elongated electric conductor is clamped fast at both ends, one of the ends being clamped fast in a locationally fixed manner and another of the ends being clamped fast in a movable gripper.

5. The method according to claim 4 wherein for straining the elongated electric conductor, the gripper executes a translatory movement wherein a travel path of the translatory movement is predefined.

6. The method according to claim 1 wherein after straining the elongated electric conductor is cut off.

7. The method according to claim 1 wherein a tape guide is employed to support from underneath and guide the elongated electric conductor while the elongated electric conductor is rolled over and pressed on the solar element by a press-on roller.

8. A device with a station for the automatic application of an elongated electric conductor to a solar element, wherein the device comprises:
a pull-out carriage and a clamping unit having means for temporarily gripping fast a free end of the elongated electric conductor;
said pull-out carriage having a gripper to temporarily grip fast the free end of the elongated electric conductor and a press-on roller to roll over and press on, wherein before rolling-over and pressing-on, the elongated electric conductor can be strained through a movement of said gripper; and
a device for monitoring a tensile limit during straining of the elongated electric conductor to prevent exceeding of a tensile limit which lies above a yield point of the elongated electric conductor.

9. The device according to claim 8 including a roll-on carriage having another press-on roller for rolling-over and pressing-on the elongated electric conductor, and a tape guide, wherein said tape guide can travel under the elongated electric conductor.

10. The device according to claim 8 including a clamping plate on said gripper for gripping fast, said clamping plate being actuatable by an eccentric shaft, said eccentric shaft being pneumatically actuatable.

11. The device according to claim 9 wherein said press-on rollers are pneumatically lowerable for setting a press-on force on rolling-over and pressing-on.

12. The device to claim 8 including a subassembly comprising said clamping unit, a cutting unit and a drive, wherein said clamping unit can execute a defined translatory relocation movement while said drive is locationally fixed.

13. The device according to claim 12 wherein said subassembly contains a compression spring which is compressed during the translatory relocation movement.

14. The device according to claim 12 wherein said subassembly includes a sensor that detects a springing back of said clamping unit relative to said drive.

15. The device according to claim 12 wherein during an approach of said pull-out carriage to said subassembly a mechanical interaction occurs that exposes a free end of the elongated electric conductor which can be clamped fast by said gripper.
